(19) United States
(12) Patent Application Publication
(10) Pub. No.: US 2004/0202186 A1
(43) Pub. Date: Oct. 14, 2004

(54) ATM bridge device and method for detecting loop in ATM bridge transmission

(75) Inventors: Ko Kimura, Tokyo (JP); Yasuhisa Kanda, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/822,668

(22) Filed: Apr. 13, 2004

(30) Foreign Application Priority Data
Apr. 14, 2003 (JP) 2003-108571

(51) Int. Cl. H04L 12/56

(52) U.S. Cl. 370/395.65; 370/401

(57) ABSTRACT

An ATM (Asynchronous Transfer Mode) bridge device is provided which is capable of removing unwanted ATM network traffic transmitted by a loop packet, of avoiding confusion of a layer 2 network caused by occurrence of erroneous learning, of rapidly identifying a point where a loop has been formed, and of preventing simultaneous formation of loops among a plurality of points caused by loop setting in a plurality of interfaces. The ATM bridge device has functions of learning a MAC (Media Access Control) address of a packet transmitted from the ATM bridge device, of filtering and monitoring a MAC address of a packet input from an ATM network and judges, when receiving a packet output from the ATM bridge device, the input packet as a loop-back packet to scrap the packet and to notify an upper network layer of the loop-back packet.

### BACKGROUND OF THE INVENTION

1. Field of the Invention

The present invention relates to an ATM (Asynchronous Transfer Mode) bridge device and a method for detecting a loop formed in ATM bridge transmission and more particularly to the ATM bridge device used for wide area LAN (Local Area Network) service and the method for detecting a loop formed in the ATM bridge.

The present application claims priority of Japanese Patent Application No.2003-108571 filed on Apr. 14, 2003, which is hereby incorporated by reference.

2. Description of the Related Art

ATM bridge transmission is technology which enables an Ethernet (Registered trademark) packet to be transmitted over an ATM network by encapsulating the Ethernet packet using an AAL5 (ATM adaptation layer 5) and an ATM bridge device is installed in a layer 2 switch. To the ATM bridge device are connected the layer 2 switch and an ATM interface. Moreover, the Ethernet format is a frame format based on a TCP/IP (Transmission Control Protocol/Internet Protocol) standard typified by an IEEE 802.3 frame format and has its various extended formats including as an IEEE 802. 1Q (VLAN, that is, virtual LAN) format or a like. The ATM network/layer 2 network connecting device of the present invention is provided as an ATM bridge device to be used for a wide area LAN network service in particular. Here, the wide area LAN service represents a LAN service in which a packet having a Ethernet frame is transmitted among points using a layer 2 (MAC (Media Access Control)/LLC (Logical Link Control) layer) according to the TCP/IP. In this service, a frame, by being encapsulated, can be transmitted via different physical layers (ATM network or a like), however, data format to be transmitted is an Ethernet packet.

In the Ethernet transmission, an individual transmission path is provided bidirectionally on both a frame receiving side and a frame transmitting side and these transmission paths are called a “port”. A frame transmitted from a facing device reaches the receiving port and a frame to be transmitted to a facing device is output from the transmitting port. The loop-back transmission represents a case where a frame received from a facing device is output through a transmitting port being paired up with the receiving port without tampering with the frame.

In a conventional layer 2 network, by using a protocol of a layer 2 and a layer 3 and by doing system design of the layers 2 and 3, a loop formed within a network is strictly monitored and, when a loop route is detected, the layer 2 network is dynamically reconstructed. Moreover, in a carrier backbone on a side of the layer 2 network, a network in which formation of a loop is minimized is constructed from a viewpoint of transmitting operations.

However, on the ATM network side, unlike in the case of the layer 2 network, since a loop detecting theory and/or a loop monitoring method are not so effective, a loop route on the ATM network side is formed easily.

In ATM transmission service in which a layer 2 packet is encapsulated in such the case as the wide area LAN service, since a loop is easily formed on the ATM network side, reconstruction of the layer 2 network is useless in preventing the formation of a loop and endless transmission of broadcast packets.

When such an ATM network loop is formed, generally, since operations on the ATM network side are managed by a centralized control station and the formation of a network loop is strictly monitored, a loop-back route is not formed theoretically.

However, in actual operations, while a device is moved or a failure occurs, maintenance work is done widely by temporarily setting the ATM network side in a loop state at an end terminal corresponding to a regional network.

At this point, since a loop in each of two or more interfaces is formed for maintenance of the ATM device, simultaneous loops can be formed easily among two or more points.

If such the loops are formed during one period due to such mechanism of loop formation as described above, damage of a band loss to the ATM network is enormous and, therefore, prevention of formation of the loops is a big problem to be solved.

To solve this problem, conventionally, a method is employed in which traffic on an ATM device side is monitored and if a broadcast packet rapidly increases and occurrence of traffic having a big band continues for a long time, a packet being transmitted is captured to find out duplicated receipt of same packets and a fact that a loop has been formed is recognized.

Then, a point where a loop has been formed is identified using information about a history of installation work being managed by a carrier and/or an analysis on transmission data and a managing section confirms the point by a phone or a like with an installation station to do work of canceling the loop processing or a like. However, this conventional method has a problem. That is, the method described above requires work of analysis by hand and tremendous work and time before the problem of formation of loops is solved.

### SUMMARY OF THE INVENTION

In view of the above, it is an object of the present invention to provide an ATM bridge device and a method for detecting a loop being formed in an ATM bridge transmission which are capable of removing unwanted ATM network traffic produced by a loop packet, of avoiding confusion of a layer 2 network caused by occurrence of erroneous learning, of rapidly identifying a point where a loop has been formed, and of preventing simultaneous formation of loops among two or more points caused by loop setting in two or more interfaces.

According to a first aspect of the present invention, there is provided an ATM bridge device to which an ATM network and a layer 2 network are connected, including:

a first learning unit to learn a transmitter address of a packet input from the ATM network and information about a transmission path through which the packet had been transmitted and to judge a destination of the packet based on a result from the learning;

a second learning unit to learn a transmitter address of a packet input from the ATM network and information about a transmission path to which the packet is to be output; and

a packet scrapping judging unit to compare the transmitter address of the packet input from the ATM network and information about the transmission path through which the packet had been transmitted with the transmitter address of the packet learnt by the second learning unit and information about the transmission path to which the packet is to be output and, if the transmitter address of the packet input from the ATM network and information about the transmission path through which the packet had been transmitted are matched with the transmitter address of the packet learnt by the second learning unit and information about the transmission path to which the packet is to be output, to scrap the packet.

As stated above, according to the present invention, in a wide area LAN service, the ATM bridge device has functions of learning a MAC address of a packet transmitted from the ATM bridge device, of filtering and monitoring a MAC address of a packet input from the ATM network and judges, when receiving a packet output from the ATM bridge device, the input packet as a loop-back packet, scraps the packet and notifies an upper network layer of formation of the loop-back packet.

In conventional cases, generally, information (MAC address, or a like) of an input packet is learnt and is held as information about a device to which the packet is to be output in a form of data base. However, the ATM bridge device of the present invention further learns information (MAC address, or a like) about the output packet and manages both the inputting and outputting of packets.

Moreover, since functions of monitoring and scrapping a loop, and notifying formation of a loop are provided on the ATM network side, formation of a loop on the ATM network side can be addressed to suppress and an influence on the layer 2 network can be reduced.

Moreover, even when a loop route is formed on the layer 2 network side, by scrapping the loop packet and notifying the formation of the loop to the ATM network, transmission of packets to the layer 2 network is made easier.

In the foregoing, a preferable mode is one wherein, when a packet is transmitted from a first device on the ATM network side to a second device on the ATM network side, a loop-back transmission mode is set to the packet to be received by the second device.

Also, a preferable mode is one wherein, when a packet is transmitted from a first device on the layer 2 network side to a second device on the ATM network side, a loop-back transmission mode is set to the packet to be received by the second device on the ATM network side.

Also, a preferable mode is one wherein, when a packet is transmitted by a broadcast method from a first device on the ATM network side to other devices on the ATM network side, a loop-back transmission mode is set to the packet to be received by a second device on the ATM network side.

Also, a preferable mode is one wherein, when a packet is transmitted by a broadcast method from a first device on the ATM network side to other devices on the ATM network side, a loop-back transmission mode is set to the packet to be received by a second device and a third device on the ATM network side.

Also, a preferable mode is one wherein, when a packet is transmitted by a broadcast method from a first device on the layer 2 network side to a device on the ATM network side, a loop-back transmission mode is set to the packet to be received by a second device on the ATM network side.

Also, a preferable mode is one wherein, when a packet is transmitted from a first device on the ATM network side to a first device on the layer 2 network side, a loop route is formed on the layer 2 network side.

Also, a preferable mode is one wherein logical transmission paths to be used for bidirectional connection in the ATM network are different from each other.

Also, a preferable mode is one wherein a VRRP (Virtual Router Redundancy Protocol) is applied to the ATM network and the layer 2 network.

According to a second aspect of the present invention, there is provided a loop detecting method for detecting a loop formed in an ATM bridge device to which an ATM network and a layer 2 network are connected, the method including:

a first learning step of learning a transmitter address of a packet input from the ATM network and information about a transmission path through which the packet had been transmitted and to judge a destination of the packet based on a result from the learning;

a second learning step of learning a transmitter address of a packet input from the ATM network and information about a transmission path to which the packet is to be output; and

a packet scrapping judging step of comparing the transmitter address of the packet input from the ATM network and information about the transmission path through which the packet had been transmitted with the transmitter address of the packet learnt in the second learning step and information about the transmission path to which the packet is to be output and, if the transmitter address of the packet input from the ATM network and information about the transmission path through which the packet had been transmitted are matched with the transmitter address of the packet learnt in the second learning step and information about the transmission path to which the packet is to be output, to scrap the packet.

In the foregoing, a preferable mode is one wherein, when a packet is transmitted from a first device on the ATM network side to a second device on the ATM network side, a loop-back transmission mode is set to the packet to be received by the second device.

Also, a preferable mode is one wherein, when a packet is transmitted from a first device on the layer 2 network side to a second device on the ATM network side, a loop-back transmission mode is set to the packet to be received by the second device on the ATM network side.

Also, a preferable mode is one wherein, when a packet is transmitted by a broadcast method from a first device on the ATM network side to other devices on the ATM network side, a Loop-back transmission mode is set to the packet to be received by a second device on the ATM network side.

Also, a preferable mode is one wherein, when a packet is transmitted by a broadcast method from a first device on the ATM network side to other devices on the ATM network side, a loop-back transmission mode is set to the packet to be received by a second device and a third device on the ATM network side.

Also, a preferable mode is one wherein, when a packet is transmitted by a broadcast method from a first device on the layer 2 network side to a device on the ATM network side, a loop-back transmission mode is set to the packet to be received by a second device on the ATM network side.

Also, a preferable mode is one wherein, when a packet is transmitted from a first device on the ATM network side to a first device on the layer 2 network side, a loop route is formed on the layer 2 network side.

Also, a preferable mode is one wherein logical transmission paths to be used for bidirectional connection in the ATM network are different from each other.

Furthermore, a preferable mode is one wherein a VRRP (Virtual Router Redundancy Protocol) is applied to the ATM network and the layer 2 network.

With the above configuration, unwanted ATM network traffic can be deleted by avoiding a loop packet, confusion of the layer 2 network caused by occurrence of erroneous learning can be prevented and a place where a loop is formed can be rapidly specified.

### BRIEF DESCRIPTION OF THE DRAWINGS

The above and other objects, advantages, and features of the present invention will be more apparent from the following description taken in conjunction with the accompanying drawings in which:

FIG. 1 is a diagram showing one example of a configuration of a communication system including an ATM bridge device of an first embodiment of the present invention;

FIG. 2 is a diagram showing an example of a configuration of a physical transmission path employed in the communication system using the ATM bridge device of the first embodiment of the present invention;

FIG. 3 is a diagram showing a concrete example of configurations of the communication system including the ATM bridge device of the first embodiment of the present invention; and

FIG. 4 is a diagram showing an example of a communication system where the present invention is applied to the case where the VRRP (Virtual Router Redundancy Protocol) is used.

### DETAILED DESCRIPTION OF THE PREFERRED EMBODIMENTS

Best modes of carrying out the present invention will be described in further detail using various embodiments with reference to the accompanying drawings.

### First Embodiment

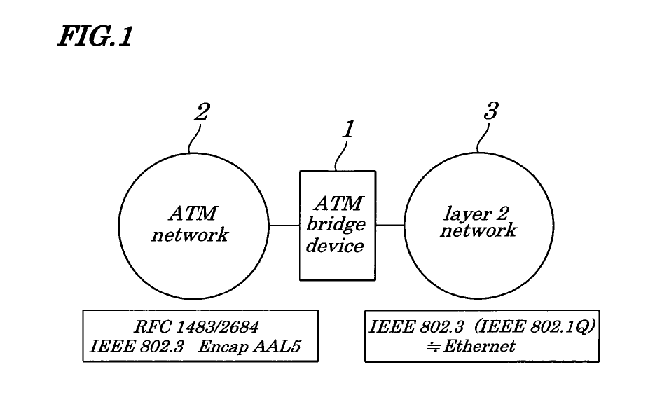

To an ATM bridge device of an embodiment of the present invention is connected an ATM network and a layer 2 network. FIG. 1 is a diagram showing one example of a configuration of a communication system including the ATM bridge device 1 of the first embodiment of the present invention. As shown in FIG. 1, the communication system includes the ATM bridge device 1, the ATM network 2, and a layer 2 network 3.

As a format of data being transmitted over the ATM network 2 and the layer 2 network 3, an IEEE 802. 3 packet frame (Ethernet packet frame) is employed. To transmit a packet over the ATM network 2, a packet fed from the layer 2 network 3 is encapsulated by an AAL5 designated in RFC 1483/2684 and is segmented into ATM cells and the segmented ATM cells are then transferred to the ATM network 2.

The ATM cells transferred from the ATM network 2 are changed by the AAL5 to their original packet that had existed before having been encapsulated according to RFC 1483/2684 and the resulting packet is transferred to the layer 2 network 3.

The ATM bridge device 1 judges, based on a MAC address contained in a packet, whether a packet is to be transferred from the ATM network 2 to the layer 2 network 3, and whether the packet is to be transferred from the layer 2 network 3 to the ATM network 2.

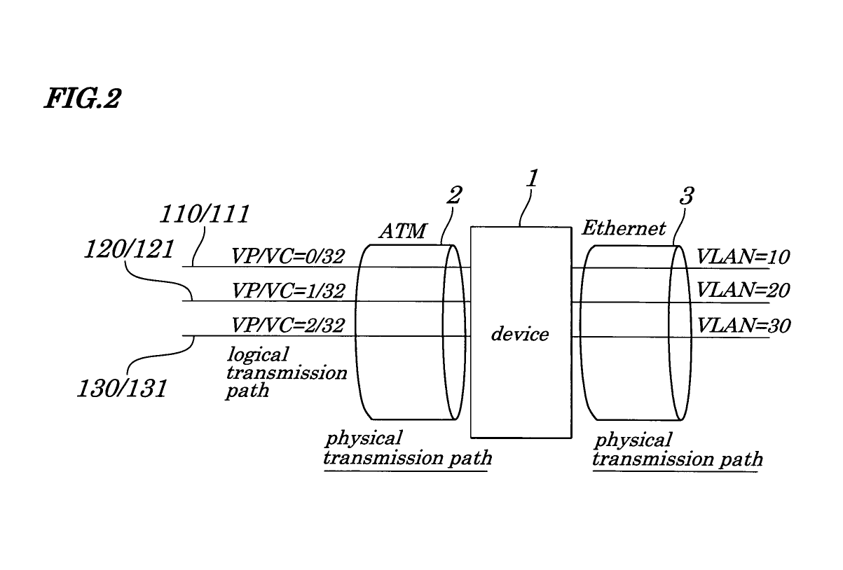

FIG. 2 is a diagram showing an example of a configuration of a physical transmission path employed in the communication system using the ATM bridge device 1 of the embodiment of the present invention. As shown in FIG. 2, each of the ATM network 2 and layer 2 network 3 has one or more physical ports. Two or more logical transmission paths can be connected to one physical port of the ATM network 2 and the layer 2 network 3. In the example shown in FIG. 2, physical transmission paths 110/111 (logical transmission paths VP (Virtual Path)/VC (Virtual Channel)=0/32) correspond to a VLAN group 10, physical transmission paths 120/121 (logical transmission paths VP/VC=1/32) correspond to a VLAN group 20, and physical transmission paths 130/131 (logical transmission paths VP/VC=2/32) correspond to a VLAN group 30.

Moreover, the ATM bridge device 1, when an IEEE 802. 1Q (VLAN) standard is applied to, even if duplication of MAC addresses or duplication of ports is found, judges, according to a group separation rule designated by an IEEE 802. 1Q tag, that the duplicated addresses or duplicated ports to be used for data transmission are different from one another.

The ATM bridge device 1 also judges, even when two or more IEEE 802. 1Q tags are provided (or stacked), according to the group separation rule designated by the IEEE 802. 1Q tag, that addresses having two or more tags to be used for data transmission are different from one another.

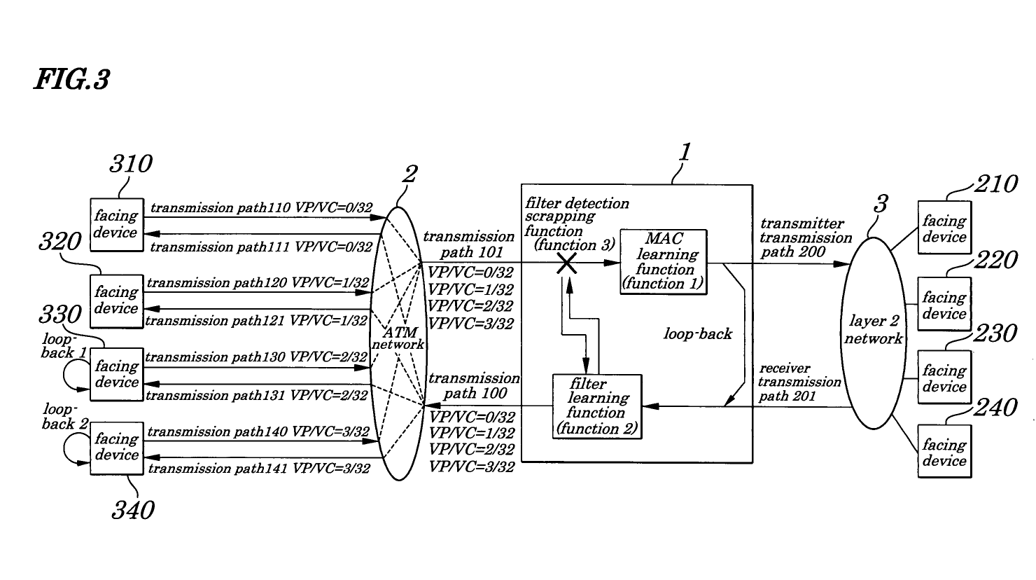

FIG. 3 is a diagram showing a concrete example of a configuration of the communication system including the ATM bridge device of the embodiment of the present invention. FIG. 3 shows an example of configurations of the ATM bridge device 1. To the ATM bridge device 1 is connected the ATM network 2 and the layer 2 network 3.

Since ATM connection identifiers (VP/VC), a MAC address, and a VLAN shown in FIG. 3 are well known to persons skilled in the art, descriptions of their detailed configurations are omitted.

Between the ATM bridge device 1 and layer 2 network 3 are provided a transmitter transmission path 200 and a receiver transmission path 201.

Between the ATM network 2 and the ATM bridge device 1 are provided a transmitter transmission path 100 and a receiver transmission path 101.

Though transmitting and receiving ports of the layer 2 network 3 and ATM network 2 are illustrated, for convenience, so that they are mounted separately, any form of mounting the transmitting and receiving ports is acceptable. Even if two or more transmission paths are connected, operations are performed by a same method. Moreover, even if two or more virtual transmission paths (logical ports) are connected to one physical transmission path (physical port), the same method can be used for operations.

In the example shown in FIG. 3, on a transmission path on the ATM network 2 side, logical transmission paths VP/VC VP (Virtual Path)/VC (Virtual Channel)=0/32, VP/VC=1/32, VP/VC=2/32, and VP/VC=3/32 are constructed.

Each of the above logical transmission paths is connected, via the ATM network 2, to each of facing devices 310, 320, 330, and 340.

The facing device 310 is connected to the ATM network 2 through transmission paths 110 and 111. The facing device 320 is connected to the ATM network 2 through transmission paths 120 and 121. The facing device 330 is connected to the ATM network 2 through transmission paths 130 and 131. The facing device 340 is connected to the ATM network 2 through transmission paths 140 and 141. On each of the transmission paths of the facing devices 310, 320, 330, and 340 is constructed each of corresponding logical transmission paths.

To the layer 2 network 3 are connected each of facing devices 210, 220, 230, and 240.

Each of the facing devices 210, 220, 230, and 240 is connected to the ATM bridge device 1 via the layer 2 network 3. Descriptions of the transmission path (Ethernet transmission path) and logical transmission path (VLAN) are omitted.

The ATM bridge device 1 has a MAC learning function (function 1) and a filter detection scrapping function (function 3) both being connected between the ATM network 2 and the layer 2 network 3 and a filter learning function (function 2) being connected between the layer 2 network 3 to the ATM network 2. Moreover, the ATM bridge device 1 has a loop-back path 50 being connected between the transmission path 200 and the transmission path 201.

Packet information includes a transmitter MAC address and VLAN identification number. Port information includes a physical transmission path number and a logical transmission path number VP/VC.

The MAC learning function (function 1) is used to learn packet information (transmitter MAC address and VLAN identification number), a physical transmission path number, for example, 101 and a logical transmission path number, for example, VP/VC=0/32, all of which are input from the ATM network 2 and to create a MAC address transfer table using the learnt information.

If a destination MAC address of a packet input from the ATM network 2 side is not found in the MAC address transfer table, the packet is output to a transmission path 200 on the layer 2 network 3 side.

If a destination MAC address of a packet input from the ATM network 2 side is found in the MAC address transfer table, the ATM bridge device 1 judges that there is a destination of the packet on the ATM network 2 side and handles the packet as a packet input from the transmission path 201 via the loop-back path 50.

If a destination MAC address of a packet input from the ATM network 2 is a broadcast packet, the ATM bridge device 1 judges that there is a destination of the packet on the ATM network 2 side and the layer 2 network 3 side and outputs the packet to the transmission path 200 on the layer 2 network 3 side and also to the loop-back path 50 to allow the packet to be output to the transmission path 100.

The filter learning function (function 2) is used to learn packet information (transmitter MAC address and VLAN identification number) and port information (transmission path number, for example, 100, or a like and logical transmission path, for example, VP/VC=0/32, or a like) as information about a device to which a packet is to be output. This function 2 is erased after a predetermined period of time has elapsed.

The filter detection scrapping function (function 3) is achieved according to a dynamic filtering operation, that is, the filter detection scrapping function (function 3) dynamically operates to compare the packet information and port information input from the ATM network 2 with information (to be handled as “filter information A”) obtained through the filtering learning of the above function 2.

If a result from the comparison indicates that there is conformity between the information input from the ATM network 2 and the information obtained by the function 2, the ATM bridge device 1 judges, by using the filter detection scrapping function (function 3), that a loop has been formed on the ATM network 2 side and scraps the packet.

On the other hand, if a result from the comparison indicates that there is no conformity between the information input from the ATM network 2 and the information obtained by the function 2, the ATM bridge device 1 judges, by using the filter detection scrapping function (function 3), that the packet input from the ATM network 2 is normal and transfers the packet.

If a result from the comparison indicates that there is conformity between the information input from the ATM network 2 and the information obtained by the function 2, the ATM bridge device 1 notifies a maintenance person that a loop is judged to have been formed based on corresponding packet information and port information (to be handled as “loop information B”) and enables the maintenance person to read the information.

Operations of the communication system using the ATM bridge device 1 of the embodiment of the present invention are described below. First, operations on the ATM network side are explained.

When a packet is transmitted from the facing device 310 on the ATM network 2 side to the facing device 320 on the ATM network 2, the ATM bridge device 1 receives the packet output using the logical transmission path VP/VC=0/32 through the transmission paths 110 and 101.

The ATM bridge device 1, since the packet destination device 320 exists on the ATM network 2 side, makes a loop-back transmission of the packet to the facing device 320 on the ATM network 2 side. The ATM bridge device 1, by using the filter detection scrapping function (function 3), judges that this packet should not be scrapped. By the MAC learning function (function 1), the loop-back path 50 is judged to be a destination of the packet. The filter learning function (function 2) is used to learn information about the packet and port.

Since an object to which the packet is to be output is the logical transmission path VP/VC=1/32 constructed on the transmission path 100, an ATM identification number is set at the logical transmission paths VP/VC=1/32 and the packet is output.

When a packet is transmitted from the facing device 310 on the ATM network 2 side to the facing device 310 on the ATM network 2 side, operations are performed according to a split horizon rule on the side of the ATM network 2, that is, the ATM bridge device 1 receives the packet output using the logical transmission path VP/VC=0/32 through the transmission paths 110 and 101.

However, the ATM bridge device 1, since the packet destination device 310 exists on the ATM network 2 side, makes a loop-back transmission of the packet to the facing device 310 on the ATM network 2 side. By the MAC learning function (function 1), the destination of the packet is judged to be the same logical port and therefore the packet is scrapped. This is a normal operation of the layer 2 switch, that is, the operation is performed according to the split horizon rule that a packet is not output to a port from which the packet is input.

Broadcast operations on the ATM network 2 side are described. When a packet is transmitted by a broadcast method from the facing device 310 on the ATM network 2 side to facing devices in the domain, the ATM bridge device 1 receives the packet output using the logical transmission path VP/VC=0/32 through the transmission paths 110 and 101.

The ATM bridge device 1, since destinations of a packet are all facing devices in the domain, makes a copy of the packet for the facing devices 320, 330, and 340 on the ATM network 2 side and makes a loop-back transmission of the packet (using the loop-back path 50) and then outputs the same packets via the logical transmission paths VP/VC=1/32, 2/32, and 3/32 constructed on the transmission path 100. Moreover, the ATM bridge device 1 outputs the above copy through the transmission path 200 to the layer 2 network 3.

At this point, the ATM bridge device 1 learns that packet information of a packet output from the ATM network 2 includes a transmitter MAC address (that is, facing device 310) and that port information includes the transmission path 100, and logical transmission paths VP/VC=1/32, 2/32, and 3/32. Such operations as above are normally performed in the ATM bridge device 1.

Here, operations performed when a loop-back transmission mode is set to a packet to be received by the facing device 330 on the ATM network 2 side are described below.

A unicast operation (No. 1) to be performed when a loop is formed on the ATM network 2 side is explained. That is, operations performed when the loop-back transmission mode “1” is set to a packet to be received by the facing device 330 on the ATM network 2 side are described. When a packet is transmitted from the facing device 310 on the ATM network 2 side to the facing devices 330 on the ATM network 2 side, the ATM bridge device 1 receives the packet output using the logical transmission paths VP/VC=0/32 through the transmission paths 110 and 101.

The ATM bridge device 1, since the packet destination device 330 exists on the ATM network 2 side, makes a loop-back transmission of the packet to the facing device 330 on the ATM network 2 side. The packet is output to the transmission path 100 (logical transmission paths VP/VC=2/32) through which the packet is to be transmitted to the facing device 330. Since the loop-back transmission mode “1” is set to the packet having been received by the facing device 330 on the ATM network 2 side, the facing device 330 outputs the packet received through the transmission path 131 to the transmission path 130 as the logical transmission path VP/VC=2/32). As a result, the packet is returned back to the ATM bridge device 1 through the transmission path 101 (logical transmission path VP/VC=2/32).

The ATM bridge device 1, though it receives the packet again, learns newly the packet information (transmitter MAC address) of the facing device 310 as new port information (logical transmission path VP/VC=2/32 constructed on the transmission path 101) and, therefore, erroneous learning of the MAC address to be used for judgement of a destination of a packet occurs.

When the ATM bridge device 1 judges again a destination of the returned packet, since the destination proves to be the facing device 330 and, therefore, the packet is not allowed to be output to the same port (according to the above split horizon rule), the packet is scrapped.

However, if, in this state, the facing device 330 transmits a packet to the facing device 310, since the ATM bridge device 1 having received the packet understands that the destination of the packet to be output is the logical transmission path VP/VC=2/32 (transmission path 130), the transmission of data is made impossible before a correct destination is learned again.

At this point, when the function of detecting a loop-back transmission provided by the ATM bridge device 1 of the embodiment of the present invention is applied to, following operations are performed.

That is, when a packet is transmitted from the facing device 310 on the ATM network 2 side to the facing device 330 on the ATM network 2 side, the ATM bridge device 1 receives the packet output using the logical transmission path VP/VC=0/32 constructed on the transmission paths 110 and 101. However, the ATM bridge device 1, since the packet destination device 330 exists on the ATM network 2 side, makes a loop-back transmission of the packet to the facing device 330 on the ATM network 2 side. At this point, the ATM bridge device, by using the filter detection scrapping function (function 3), judges that the packet should not be scrapped and is to be transmitted through the network and also judges, by using the MAC learning function (function 1), that the destination of the packet is the loop-back path 50, and then learns, by using the filter learning function (function 2), packet information (the transmitter MAC address being the facing device 310) and port information (the output transmission path 100 having the logical transmission path VP/VC=2/32).

The packet is output to the transmission path 100 (logical transmission path VP/VC=2/32) through which the packet is to be transmitted to the facing device 330. Since the loop-back transmission mode “1” is set to the packet having been received through the transmission path 131, the facing device 330 outputs the packet through the transmission path 130 (logical transmission path VP/VC=2/32). As a result, the packet is returned back to the transmission path 101 (logical transmission path VP/VC=2/32) of the ATM bridge device.

The ATM bridge device 1, though it receives the packet again, learns by using the filter detection scrapping function (function 3), that the received packet information includes the transmitter MAC address (facing device 310) and the port information includes the transmission path 100 (logical transmission path VP/VC=2/32) and, therefore, judges, by loop information A, that the packet transmitted from the ATM bridge device 1 has been looped back and scraps the packet accordingly.

Moreover, the ATM bridge device 1 holds the loop information as “loop information B” and allows a maintenance person to read the loop information B. These operations can prevent erroneous learning of packets.

A unicast operation (No. 2) performed when a loop is formed on the ATM network 2 side is described below. That is, operations performed when the loop-back transmission mode “1” is set to a packet to be received by the facing device 330 on the ATM network 2 side are described. When a packet is transmitted from the facing device 210 on the layer 2 network 3 side to the facing device 330 on the ATM network 2, the ATM bridge device 1 receives the packet through the transmission path 201.

The ATM bridge device 1, since the packet destination device 330 exists on the ATM network 2 side, outputs the packet to the transmission path 100 (logical transmission path VP/VC=2/32) through which the packet is to be transmitted to the facing device 330. The facing device 330, since the loop-back transmission mode “1” is set to the packet to be received by the facing device 330, outputs the packet received via the transmission path 131 to the transmission path 130 (logical transmission path VP/VC=2/32) of the ATM bridge device. As a result, the output packet is returned back to the transmission path 101 (logical transmission path VP/VC=2/32) of the ATM bridge device 1.

The ATM bridge device 1, though it receives the packet again, learns newly the packet information (transmitter MAC address) of the facing device 210 as new port information (transmission path 101 having logical transmission path VP/VC=2/32) and, therefore, erroneous learning of the MAC address to be used for judgement of a destination of a packet occurs.

When the ATM bridge device 1 judges again a destination of the returned packet, since the destination proves to be the facing device 330 and, therefore, the packet is not allowed to be output to the same port (according to the above-mentioned split horizon rule), the packet is scrapped accordingly.

However, if, in this state, the facing device 330 transmits a packet to the facing device 210, since the ATM bridge device 1 having received the packet understands that the destination of the packet to be output is the logical transmission path VP/VC=2/32 (transmission path 130), the transmission of data is made impossible before a correct destination is learned again.

At this point, when the function of detecting a loop-back transmission provided by the ATM bridge device 1 of the embodiment of the present invention is applied to, following operations are performed.

When a packet is transmitted from the facing device 210 on the layer 2 network 3 side to the facing devices 330 on the ATM network 2, the ATM bridge device 1 receives the packet through the transmission paths 201.

The ATM bridge device 1, since the packet destination device 330 exists on the ATM network 2 side, outputs the packet to the transmission path 100 (logical transmission path VP/VC=2/32) through which the packet is to be transmitted to the facing device 330.

At this point, the ATM bridge device 1, by using the filter learning function (function 2), learns the packet information (transmitter MAC address being the device 210) and port information (output port transmission path 100 and logical transmission path VP/VC=2/32).

Since the loop-back transmission mode “1” is set to the packet received through the transmission path 131, the facing device 330 outputs the packet to the transmission path 130 (logical transmission path VP/VC=2/32). As a result, the packet is returned back to the transmission path 101 (logical transmission path VP/VC=2/32) of the ATM bridge device 1.

The ATM bridge device 1, though it receives a packet again, learns, by the filter detection scrapping function (function 3), that the received packet information includes the transmitter MAC address (facing device 210) and the port information includes the transmission path 100 (logical transmission path VP/VC=2/32) and therefore judges, by using the “loop information A”, that the packet transmitted from the same facing device 210 has been looped back and the ATM bridge device 1 scraps the packet accordingly.

Moreover, the ATM bridge device 1 holds the loop information as “loop information B” and allows a maintenance person to read the “loop information B”. These operations can prevent erroneous learning of packets.

Broadcast transmitting operation performed when a loop-back transmission mode “1” is set to a packet to be received by the facing device 330 on the ATM network 2 are described. When a packet is transmitted by a broadcast method from the facing device 310 on the ATM network 2 side to the facing devices within the domain, the ATM bridge device 1 receives the packet output by using the logical transmission path VP/VC=0/32 through the transmission paths 110 and 101.

The ATM bridge device 1, since destinations of a packet are all facing devices in the domain, makes a copy of the packet for the facing devices 320, 330, and 340 on the ATM network 2 side and makes a loop-back transmission of the packet and then outputs the same packet via the logical transmission paths VP/VC=1/32, and 2/32, and 3/32 constructed on the transmission path 100. Moreover, the ATM bridge device 1 outputs the above copy by the broadcast method through the transmission path 200 to the layer 2 network 3.

The facing device 330, since the loop-back transmission mode 1 is set to the packet to be received through the transmission path 131, outputs the packet received via the logical transmission path VP/VC=2/32 constructed on the transmission path 130. As a result, the output packet is returned back to the transmission path 101 (logical transmission path VP/VC=2/32) of the ATM bridge device 1.

The ATM bridge device 1, though it receives the packet again, learns newly the packet information (transmitter MAC address) of the ATM bridge device 1 as new port information (transmission path 101 having the logical transmission path VP/VC=2/32) and, therefore, erroneous learning of the MAC address to be used for judgement of a destination of a packet occurs.

The ATM bridge device 1, when judging again the destinations of the returned packet and understanding that the destinations of the packet are all facing devices in the domain, makes a copy of the packet for the facing devices 310, 320, and 340 on the ATM network 2 side and makes a loop-back transmission of the packet and then outputs the same packet via the logical transmission paths VP/VC=0/32, 1/32, and 3/32 constructed on the transmission path 100. Moreover, the ATM bridge device 1 transmits, by a broadcast method, the above copy through the transmission path 200 to the layer 2 network 3.

As a result, in the ATM bridge device 1, since a packet having been already output is returned back from a sane port, erroneous learning of the MAC address occurs and re-construction of a path is started. Moreover, the facing devices 320 and 340, and the layer 2 network 3 receive the same packet twice.

Therefore, as in the case of the unicast transmitting operation, data transmission is made impossible before a correct destination is learned.

As described above, in a TCP/IP (Transmission Control Protocol/Internet Protocol) communication in which transmission of data begins with an ARP (Address Resolution Protocol) packet (broadcast packet), if a loop is formed at one point in the ATM network 2, there is a possibility that normal transmission is made impossible in all points being connected to a network.

At this point, when the function of detecting a loop-back transmission provided by the ATM bridge device 1 of the embodiment of the present invention is applied to, following operations are performed.

When a packet is transmitted by a broadcast method from the facing device 310 on the ATM network 2 side to the facing devices within the domain, the packet to be transmitted is output via the logical transmission path VP/VC=0/32 constructed on the transmission paths 110 and 101 to the ATM bridge device 1.

The ATM bridge device 1, since destinations of the packet are all facing devices within the domain, makes a copy of the packet for the facing devices 320, 330, and 340 on the ATM network 2 side and makes a loop-back transmission of the packet and then outputs the same packet via the logical transmission paths VP/VC=1/32, 2/32, and 3/32 constructed on the transmission path 100. Moreover, the ATM bridge device 1 outputs the above copy by the broadcast method through the transmission path 200 to the layer 2 network 3.

At this point, the ATM bridge device 1, by using the filter detection scrapping function (function 3), judges that the packet should not be scrapped and is to be transmitted through the network and also judges, by using the MAC learning function (function 1), that the destination of the packet is the loop-back path 50, and learns, by using the filter learning function (function 2), packet information (the transmitter MAC address being the facing device 310) and port information (the output transmission path 100 (logical transmission path VP/VC=1/32, 2/32, and 3/32).

Since the loop-back transmission mode “1” is set to the packet received through the transmission path 131, the facing device 330 outputs the packet to the transmission path 130 (logical transmission path VP/VC=2/32). As a result, the packet is returned back to the transmission path 101 (logical transmission path VP/VC=2/32) of the ATM bridge device 1.

The ATM bridge device 1, though it receives the packet again, learns by using the filter detection scrapping function (function 3), that the received packet information includes the transmitter MAC address (facing device 310) and the port information includes the transmission path 100 (logical transmission path VP/VC=2/32) and therefore judges, by using “loop information A”, that the packet transmitted from the ATM bridge device 1 has been looped back and scraps the packet accordingly.

Moreover, the ATM bridge device 1 holds the loop information as “loop information B” and allows a maintenance person to read the loop information B. These operations can prevent erroneous learning of packets and unwanted transfer of a packet.

Broadcast operation to be performed when a loop is formed on the ATM network 2 side and when a plurality of loops are formed in two points is explained. That is, operations performed when the loop-back transmission mode “1” is set to a packet to be received by the facing device 330, and the loop-back transmission mode “2” is set to a packet to be received by the facing device 340 on the ATM network 2 side are described.

When a packet is transmitted by a broadcast method from the facing device 310 on the ATM network 2 side to facing devices within the domain, the ATM bridge device 1 receives the packet output via the logical transmission path VP/VC=0/32 constructed on the transmission paths 110 and 101.

The ATM bridge device 1, since destinations of a packet are all facing devices in the domain, makes a copy of the packet for the facing devices 320, 330, and 340 on the ATM network 2 side and makes a loop-back transmission of the packet and then outputs the same packet via the logical transmission paths VP/VC=1/32, 2/32, and 3/32 constructed on the transmission path 100. Moreover, the ATM bridge device 1 outputs the above copy through the transmission path 200 to the layer 2 network 3.

Since the loop-back transmission mode “1” is set to the packet received through the transmission path 131, the facing device 330 outputs the packet through the logical transmission path VP/VC=2/32 constructed on the transmission path 130. As a result, the packet is returned back to the transmission path 101 (logical transmission path VP/VC=2/32) of the ATM bridge device 1.

Since the loop-back transmission mode “2” is set to the packet received through the transmission path 141, the facing device 340 outputs the packet through the logical transmission path VP/VC=3/32 constructed on the transmission path 140. As a result, the packet is returned back to the transmission path 101 (logical transmission path VP/VC=3/32) of the ATM bridge device 1.

The ATM bridge device 1, though it receives the packet again, learns newly the packet information (transmitter MAC address) of the facing device 310 as new port information. At this point, in order of arrival of the packet to be received, original information is overwritten with information about the transmission path 101 having the logical transmission path VP/VC=2/32 and about the transmission path 101 having the logical transmission path VP/VC=3/32.

The ATM bridge device 1, when judging again destinations of the packet having returned from the facing device 330, learns that destinations of the packet are all facing devices in the domain, makes a copy of the packet for the facing devices 310, 320, and 340 on the ATM network 2 side, makes a loop-back transmission of the packet, and outputs the same packet via the logical transmission paths VP/VC=0/32, 1/32, and 3/32 constructed on the transmission path 100. Moreover, the ATM bridge device 1 outputs the above copy through the transmission path 200 to the layer 2 network 3.

The ATM bridge device 1, when judging again destinations of the packet having returned from the facing device 340, learns that destinations of the packet are all facing devices in the domain, makes a copy of the packet for the facing devices 310, 320, and 330 on the ATM network 2 side, makes a loop-back transmission of the packet, and outputs the same packet via the logical transmission paths VP/VC=0/32, 1/32, and 2/32 constructed on the transmission path 100. Moreover, the ATM bridge device 1 outputs the above copy through the transmission path 200 to the layer 2 network 3.

As a result, unlike in the case in which the number of loop routes is one, if loops are formed among two or more points, broadcast packets continue going around endlessly and are output unlimitedly to the facing devices 310, 320, 330, and 340 and the transmission path 200 on the layer 2 network 3 side to be connected.

In this state, when the function of detecting a loop-back transmission provided by the ATM bridge device 1 of the embodiment of the present invention is applied to, following operations are performed,

When a packet is transmitted by a broadcast method from the facing device 310 on the ATM network 2 side to facing devices within the domain, the ATM bridge device 1 receives the packet output via the logical transmission path VP/VC=0/32 constructed on the transmission paths 110 and 101.

The ATM bridge device 1, since destinations of the packet are all facing devices in the domain, makes a copy of the packet for the facing devices 320, 330, and 340 on the ATM network 2 side and makes a loop-back transmission of the packet and then outputs the same packet via the logical transmission paths VP/VC=1/32, 2/32, and 3/32 constructed on the transmission path 100. Moreover, the ATM bridge device 1 outputs the above copy through the transmission path 200 to the layer 2 network 3.

At this point, the ATM bridge device, by using the filter detection scrapping function (function 3), judges that the packet should not be scrapped and is to be transmitted through the network and also judges, by using the MAC learning function (function 1), that the destination of the packet is the loop-back path 50, and learns, by using the filter learning function (function 2), packet information (the transmitter MAC address being the facing device 310) and port information (the output transmission path 100 (logical transmission path VP/VC=1/32, 2/32, and 3/32).

Since the loop-back transmission mode “1” is set to the packet received through the transmission path 131, the facing device 330 outputs the packet through the logical transmission path VP/VC=2/32 constructed on the transmission path 130. As a result, the packet is returned back to the transmission path 101 (logical transmission path VP/VC=2/32) of the ATM bridge device 1.

Since the loop-back transmission mode “2” is set to the packet received through the transmission path 141, the facing device 340 outputs the packet through the logical transmission path VP/VC=3/32 constructed on the transmission path 140. As a result, the packet is returned back to the transmission path 101 (logical transmission path VP/VC=3/32) of the ATM bridge device 1.

The ATM bridge device 1, though it receives the packet again, learns by using the filter detection scrapping function (function 3), that the received packet information includes the transmitter MAC address (facing device 310) and the port information includes the transmission path 100 (logical transmission paths VP/VC=2/32 and VP/VC=3/32) and, therefore, judges, by the “loop information A”, that the packet transmitted from the ATM bridge device 1 has been looped back and scraps the packet accordingly.

Moreover, the ATM bridge device 1 holds the loop information as “loop information B” and allows a maintenance person to read the “loop information B”. These operations can prevent erroneous learning of packets and transfer of unwanted packets.

Broadcast operations to be performed when a loop is formed on the ATM network 2 side are explained. That is, operations performed when the loop-back transmission mode “1” is set to a packet to be received by the facing devices 330 on the ATM network 2 side are described. When a packet is transmitted by a broadcast method from the facing device 210 on the layer 2 network 3 side to facing devices in the domain, the ATM bridge device 1 receives the packet output through the transmission path 201.

The ATM bridge device 1, since destinations of the packet are all facing devices in the domain, makes a copy of the packet for the facing devices 310, 320, 330, and 340 on the ATM network 2 side and then outputs the same packet via the logical transmission paths VP/VC=0/32, 1/32, 2/32, and 3/32 constructed on the transmission path 100.

Since the loop-back transmission mode “1” is set to the packet received through the transmission path 131, the facing device 330 outputs the packet through the logical transmission path VP/VC=2/32 constructed on the transmission path 130. As a result, the packet is returned back to the transmission path 101 (logical transmission path VP/VC=2/32) of the ATM bridge device. 1.

The ATM bridge device 1, though it receives the packet again, learns newly the packet information (transmitter MAC address) of the facing device 210 as new port information (logical transmission path VP/VC=2/32 constructed on the transmission path 101) and, therefore, erroneous learning of the MAC address to be used for judgement of a destination of a packet occurs.

The ATM bridge device 1, when judging again destinations of the packet having returned, learns that destinations of the packet are all facing devices in the domain, makes a copy of the packet, makes a loop-back transmission of the packet, and outputs the same packet via the logical transmission paths VP/VC=0/32, 1/32, and 3/32 constructed on the transmission path 100 to the facing devices 310, 320, and 340 on the ATM network 2 side. Moreover, the ATM bridge device 1 outputs the above copy through the transmission path 200 to the layer 2 network 3.

As a result, devices on the ATM network 2 side, though receiving a normal packet, since a packet having been already output to the layer 2 network 3 side is returned back from a same port, erroneous learning of the MAC address occurs and re-construction of a path for the layer 2 network 3 is started.

These erroneous learning and re-construction affect greatly convergence on the layer 2 network 3 side and produce a risk of occurrence of a big band loss on the layer 2 network 3.

In this state, when the function of detecting a loop-back transmission provided by the ATM bridge device 1 of the embodiment of the present invention is applied to, following operations are performed.

When a packet is transmitted by a broadcast method from the facing device 210 on the layer 2 network 3 side to facing devices within the domain, the ATM bridge device 1 receives the packet output through the transmission path 201.

The ATM bridge device 1, since destinations of the packet are all facing devices in the domain, makes a copy of the packet and makes a loop-back transmission of the packet and then outputs the same packet via the logical transmission paths VP/VC=0/32, 1/32, 2/32, and 3/32 to the facing devices 310, 320, 330, and 340 on the ATM network 2 side. At this point, the ATM bridge device 1 learns, by using the filter learning function (function 2), packet information (the transmitter MAC address being the facing device 210) and port information (the output transmission path 100 (logical transmission path VP/VC=0/32, 1/32, 2/32, and 3/32).

Since the loop-back transmission mode “1” is set to the packet received through the transmission path 131, the facing device 330 outputs the packet via the logical transmission path VP/VC=2/32 constructed on the transmission path 130. As a result, the packet is returned back to the transmission path 101 (logical transmission path VP/VC=2/32) of the ATM bridge device 1.

The ATM bridge device 1, though it receives the packet again, learns by using the filter detection scrapping function (function 3), that the received packet information includes the transmitter MAC address (facing device 210) and the port information includes the transmission path 100 (logical transmission path VP/VC=2/32) and therefore judges, by using “loop information A”, that the packet transmitted from the ATM bridge device 1 has been looped back and scraps the packet accordingly.

Also, the ATM bridge device 1 holds the loop information as “loop information B” and allows a maintenance person to read the “loop information B”. These operations can prevent erroneous learning of packets. As a result, both formation of a loop of a packet in the layer 2 network 3 and re-construction of a path for the layer 2 network 3 can be suppressed.

A unicast operation to be performed when a loop is formed on the layer 2 network 3 is explained. That is, operations performed when the loop-back transmission mode is set to a packet to be received on the layer 2 network 3 side are described. When a packet is transmitted from the facing device 310 on the ATM network 2 side to the facing devices 210 on the layer 2 network 3 side, the ATM bridge device 1 receives the packet output via the logical transmission path VP/VC=0/32 constructed on the transmission paths 110 and 101.

The ATM bridge device 1, since the packet destination facing device 210 is on the layer 2 network 3 side, transfers a packet to the layer 2 network 3. The packet is output to the transmission path 200 being a destination of the facing device 210.

At this point, if a loop route is formed on the layer 2 network 3 side , a packet is returned back to the transmission path 201 of the ATM bridge device 1.

The ATM bridge device 1, since the packet received through the transmission path 201 is one having unknown destination, makes a copy of the packet and outputs the same packet to the facing devices 310, 320, 330, and 340 on the ATM network 2 side via the logical transmission paths VP/VC=0/32, 1/32, 2/32, and 3/32 constructed on the transmission path 100.

As a result, in the facing device 310 on the ATM network 2, since a packet having been already output is returned back from the same port, erroneous learning of the MAC address occurs and re-construction of a path is started. Moreover, the devices 320, 330, and 340 receive unwanted packet. If packets are output from the facing device 310, the above operations are repeated.

In this state, when the function of detecting a loop-back transmission provided by the ATM bridge device 1 of the embodiment of the present invention is applied to, following operations are performed.

When a packet is transmitted from the facing device 310 to the facing device 210 on the layer 2 network 3 side, the ATM bridge device 1 receives the packet output via the logical transmission path VP/VC=0/32 constructed on the transmission paths 110 and 101.

The ATM bridge device 1, since the packet destination facing device 210 is on the layer 2 network 3 side, transfers the packet to the layer 2 network 3. The packet is output to the transmission path 200 being a destination of the facing device 210.

At this point, when a loop route is formed on the layer 2 network 3, the packet is returned back to the transmission path 201 of the ATM bridge device 1.

The ATM bridge device 1, since the packet received through the transmission path 201 is one having unknown destination, makes a copy of the packet and outputs the same packet to the facing devices 310, 320, 330, and 340 on the ATM network 2 side via the logical transmission paths VP/VC=0/32, 1/32, 2/32, and 3/32 constructed on the transmission path 100.

At this point, the ATM bridge device 1 learns, by using the filter learning function (function 2), packet information (the transmitter MAC address being the facing device 310) and port information (the output transmission path 100 (logical transmission path VP/VC=0/32, 1/32, 2/32, and 3/32).

When a packet is again transmitted from the ATM bridge device 1, by using the filter detection scrapping function (function 3), the packet is scrapped based on the packet information and port information. Moreover, the ATM bridge device 1 holds the loop information as “loop information B” and allows a maintenance person to read the “loop information B”.

This operation can suppress, when a loop is formed on the layer 2 network 3, transfer of a packet from the ATM network 2 to the loop route.

### Second Embodiment

Basic configurations of the communication system using the ATM network 2, ATM bridge device 1 and layer 2 network 3 of the second embodiment are the same as those shown in the first embodiment. However, in the second embodiment, bidirectional logical transmission paths (numbers of their ATM connection identifiers VP/VC) for connection are different from each other. That is, the logical transmission paths (VP/VC) are dynamically set and therefore a logical transmission path (VP/VC) to be used from a point A to a point B is different from a logical transmission path (VP/VC) to be used from the point B to the point A. For example, the logical transmission path to be used for connection from the point A to the point B is VP/VC=0/32 and the logical transmission path to be used for connection from the point B to the point A is VP/VC=3/4580. In this state, if the ATM bridge device 1 is connected to the point B, the logical transmission path for connection to receive a packet is VP/VC=0/32 and the logical transmission path for connection to transmit a packet is VP/VC=3/4580.

At this point, the connection for transmitting may be different from the connection for receiving a packet. To address such the case, by associating the transmitting of a packet with the receiving of a packet using the logical transmission path VP/VC as a pair of relations, a loop detecting theory to be used when a packet having been already transmitted is again received can be applied.

It the same VP/VC numbers are used, 0/32 are assigned for transmitting a packet and 0/32 are assigned for receiving a packet. If the different VP/VC numbers are used, 0/32 are assigned for transmitting a packet and 3/4580 are assigned for receiving a packet. Thus, associating a connection identifier for transmitting a packet with a connection identifier for receiving a packet as a pair of relations, the above loop detecting theory can be applied.

### Third Embodiment

Basic configurations of the communication system using the ATM network 2, ATM bridge device 1 and layer 2 network 3 of the second embodiment are the same as those shown in the first embodiment. However, in the second embodiment, a VRRP is employed in the ATM network 2 and the layer 2 network 3.

The VRRP enables the same MAC address to be used by two or a plurality of switches/routers. When the VRRP is applied, the loop detection function has to be supported in a limited way.

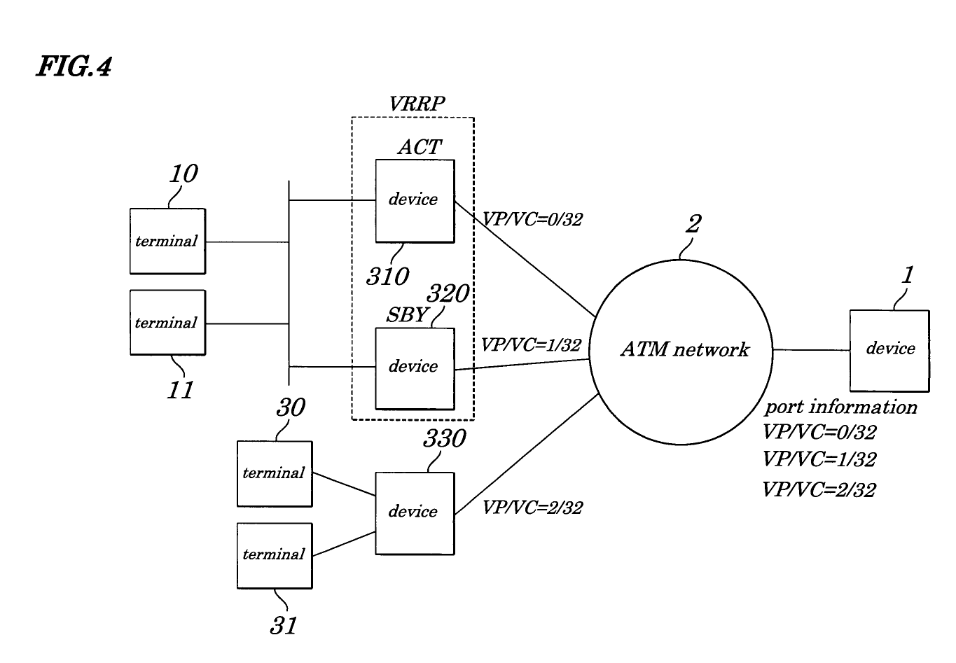

Operations performed when the present invention is applied to the case where the VRRP is used in the communication system are described. FIG. 4 is a diagram showing an example of a communication system where the present invention is applied to the case where the VRRP is used. As shown in FIG. 4, for example, the VRRP is applied to facing devices 310 and 320. A same MAC address is used in a duplicated manner, however, port information to be received is different. Let it be assumed that the device 310 continuing packet communication is an active system (ACT system) and the device 320 is a standby system (SBY system).

There are some cases in which, when the device 310 suffers a breakdown and a packet is transmitted immediately from the device 320, a loop is detected by the ATM bridge device 1 of the present invention. In this case, the dynamic loop detecting function of the present invention is employed and connection is cut for a period before filter learning information is deleted. Even if a loop is formed, by providing a period during which the filter learning information is deleted, within general converging time of the VRRP, operations of the communication system can be performed without any trouble.

As described above, following effects can be achieved by the embodiments of the present invention:

(1) A loop-back packet being transmitted on the ATM network side can be detected and notified.

(2) A loop-back packet occurring on the ATM network side can be scrapped and duplicated traffic can be avoided.

(3) Erroneous learning caused by occurrence of loop-back transmission of the ATM network can be avoided and normal communication can be ensured.

(4) An endless loop caused by loops connected to two or more points on the ATM network side can be avoided.

(5) When loop-back transmission occurs on the layer 2 network, transmission of unwanted packet can be prevented.

(6) Erroneous learning caused by formation of a loop on the layer 2 network 3 side can be prevented.

(7) By learning a transmitter MAC address and destination logical transmission paths VP/VC of a transmitted packet, when the same transmitter MAC address using the same logical transmission paths VP/VC is detected, it can be judged that loop-back transmission has occurred on the ATM network side. This is due to a general rule that a MAC address has to be determined uniquely within an operating layer 2 network and connected ATM network. That is, transmission and receipt of a packet at a moment is monitored and MAC addresses used in the transmission and receipt of the packet is also monitored and, if a packet having the same transmitter MAC address is returned, it can be judged that a loop has been formed or the MAC address is duplicated. In the case of a network in which a LAN is applied, by referring to a MAC address and a VLAN identification number, the same MAC address can be used. However, if the VLAN identification number and MAC address are duplicated, it can be judged that a loop has been formed.

(8) In the case where the present invention is applied to the communication system using the ATM bridge device in which the VRRP is used, formation of a loop in the ATM network can be prevented. Moreover, a loop-back packet on the ATM network side can be scrapped and duplicated traffic can be avoided.

(9) Formation of an endless loop on the ATM network side can be prevented.

(10) Erroneous learning of MAC addresses can be prevented.

(11) Erroneous learning of MAC addresses to be used for judging a transfer path to the ATM network and layer 2 network can be prevented.

(12) Influence on a loop to the layer 2 network can be reduced.

(13) When a loop route is formed on the layer 2 network 3 side, transfer of a packet from the ATM network can be scrapped thereafter.

(14) By flowing no unwanted packet to the layer 2 network, erroneous learning on the layer 2 network can be prevented.

(15) By flowing no unwanted broadcast packet to the layer 2 network, congestion on the layer 2 network 3 side can be avoided.

(16) In the case in which a VLAN group is applied, following effects can be obtained. That is, in a device in which an Ethernet over ATM network is connected to the layer 2 network, when the VLAN group is applied, by adding a function of learning an identification number of a VLAN group to the original learning function, functions of detecting and preventing an ATM loop in unit of the VLAN can be realized.

(17) ATM connection in which a loop is formed can be identified. By learning the connection identifier on the ATM network side to detect loop-back transmission on the ATM networks a place where a loop is produced in the network can be judged.

(18) Collection of information about detected time and the number of times of the detection is made possible.

(19) By learning time during which the learning has been made, the number of packets put in a loop state, types of loop packets, more detailed information can be provided. By the learning function, a destination MAC address, a transmitter MAC address, a VLAN group identifier, an ATM network connection identifier (VP/VC numbers) having received a loop packet, time which has detected a loop, a number of detected packets and types (less than 64 bytes, 64 bytes, 64 bytes to 128 bytes, 128 bytes to 256 bytes, 256 bytes to 1024 bytes, 1024 bytes to 1518 bytes, and more than 1518 bytes, broadcast packet, multicast packet, packets to be used exclusively for a protocol) or a like can be learned.

(20) Dynamic scrapping of a loop packet is made possible. Transmission of a packet on the ATM network side can be dynamically learned and the scrapping function is applied immediately and therefore, immediately after formation of a loop route of any type, the loop route can be removed.

(21) The number of MAC addresses to be learned can be limited, that is, dynamic detection of a loop can be applied. Now let it be assumed that turnaround time (that is, time required from when a packet is transmitted to when the packet is received through a loop-back transmission path) of a loop on the ATM network side is about 10 ms by taking the number of nodes of the ATM, transmission speed, and operation speed of a device into consideration. During this time, the maximum number of MAC addresses that can be learned by passage of one piece of the layer 2 switch can be calculated as follows:

148, 809 fps×(1/100 s)=1, 488 frame/10 ms.

This means that, if about 1500 MAC addresses can be learned, complete detection of a loop within 10 ms can be made possible. Moreover, by deleting (using an aging method) information about a transmitter MAC address of a transmitted packet or a like, which was used for detection of a loop, rapid re-use of a hardware circuit (resource) is made possible. Thus, by limiting loop learning time obtained by theoretical calculation, a scale of the hardware circuit can be easily made small.

(22) Filter learning can be dynamically cancelled (by limiting aging time). By theoretically calculating a loop period of a MAC address and by setting the theoretical maximum delay time of a loop packet by considering turnaround time of a loop on the ATM network side as in the case of the number of times of filter learning, dynamic opening of a filter learning table (deletion of table information) is made possible.

(23) In order for the filtering function to allow dynamic detection and canceling of a loop to be repeated, it is desirous that opening of filtering learning is performed during time before a return of a packet. As a result, the shorter the filtering aging time is, the smaller the scale of the hardware can be made.

(24) Static scrapping of a loop packet is made possible. By setting so that filtering learning is performed statically, a function of detecting a loop in advance is activated before conventional setting of a loop required for a movement of a device and, therefore, an influence on the ATM network can be made minimized.

(25) A range of networks in which functions of configurations of the ATM bridge device can be applied can be extended. Functions of the configurations of the ATM bridge device can be applied to a network of a point-to-point structure in which an Ethernet packet (IEEE 802.3 format) is transmitted. For example, the above functions can be used in a HDLC (High Level Data Link Control) network, a frame relay network, an ATM network, or a like.

It is apparent that the present invention is not limited to the above embodiments but may be changed and modified without departing from the scope and spirit of the invention.

What is claimed is:

1. An ATM (Asynchronous Transfer Mode) bridge device to which an ATM network and a layer 2 network are connected, comprising:
a first learning unit to learn a transmitter address of a packet input from said ATM network and information about a transmission path through which said packet had been transmitted and to judge a destination of said packet based on a result from the learning,
a second learning unit to learn a transmitter address of a packet input from said ATM network and information about a transmission path to which said packet is to be output; and
a packet scrapping judging unit to compare said transmitter address of said packet input from said ATM network and information about said transmission path through which said packet had been transmitted with said transmitter address of said packet learnt by said second learning unit and information about said transmission path to which said packet is to be output and, if said transmitter address of said packet input from said ATM network and information about said transmission path through which said packet had been transmitted are matched with said transmitter address of said packet learnt by said second learning unit and information about said transmission path to which said packet is to be output, to scrap said packet.

2. The ATM bridge device according to claim 1, wherein, when a packet is transmitted from a first device on the ATM network side to a second device on said ATM network side, a loop-back transmission mode is set to said packet to be received by said second device.

3. The ATM bridge device according to claim 1, wherein, when a packet is transmitted from a first device on the layer 2 network side to a second device on said ATM network side, a loop-back transmission mode is set to said packet to be received by said second device on said ATM network side.

4. The ATM bridge device according to claim 1, wherein, when a packet is transmitted by a broadcast method from a first device on said ATM network side to other devices on said ATM network side, a loop-back transmission mode is set to said packet to be received by a second device on said ATM network side.

5. The ATM bridge device according to claim 1, wherein, when a packet is transmitted by a broadcast method from a first device on said ATM network side to other devices on said ATM network side, a loop-back transmission mode is set to said packet to be received by a second device and a third device on said ATM network side.

6. The ATM bridge device according to claim 1, wherein, when a packet is transmitted by a broadcast method from a first device on said layer 2 network side to a device on said ATM network side, a loop-back transmission mode is set to said packet to be received by a second device on said ATM network side.

7. The ATM bridge device according to claim 1, wherein, when a packet is transmitted from a first device on said ATM network side to a first device on said layer 2 network side, a loop route is formed on said layer 2 network side.

8. The ATM bridge device according to claim 1, wherein logical transmission paths to be used for bidirectional connection in said ATM network are different from each other.

9. The ATM bridge device according to claim 1, wherein a VRRP (Virtual Router Redundancy Protocol) is applied in said ATM network and said layer 2 network.

10. A loop detecting method for detecting a loop formed in an ATM bridge device to which an ATM network and a layer 2 network are connected, said method comprising:
a first learning step of learning a transmitter address of a packet input from said ATM network and information about a transmission path through which said packet had been transmitted and to judge a destination of said packet based on a result from the learning;
a second learning step of learning a transmitter address of a packet input from said ATM network and information about a transmission path to which said packet is to be output; and
a packet scrapping judging step of comparing said transmitter address of said packet input from said ATM network and information about said transmission path through which said packet had been transmitted with said transmitter address of said packet learnt in said second learning step and information about said transmission path to which said packet is to be output and, if said transmitter address of said packet input from said ATM network and information about said transmission path through which said packet had been transmitted are matched with said transmitter address of said packet learnt in said second learning step and information about said transmission path to which said packet is to be output, to scrap said packet.

11. The loop detecting method according to claim 10, wherein, when a packet is transmitted from a first device on said ATM network side to a second device on said ATM network side, a loop-back transmission mode is set to said packet to be received by said second device.

12. The loop detecting method according to claim 10, wherein, when a packet is transmitted from a first device on said layer 2 network side to a second device on said ATM network side, a loop-back transmission mode is set to said packet to be received by said second device on said ATM network side.

13. The loop detecting method according to claim 10, wherein, when a packet is transmitted by a broadcast method from a first device on said ATM network side to other devices on said ATM network side, a loop-back transmission mode is set to said packet to be received by a second device on said ATM network side.

14. The loop detecting method according to claim 10, wherein, when a packet is transmitted by a broadcast method from a first device on said ATM network side to other devices on said ATM network side, a loop-back transmission mode is set to said packet to be received by a second device and a third device on said ATM network side.

15. The loop detecting method according to claim 10, wherein, when a packet is transmitted by a broadcast method from a first device on said layer 2 network side to a device on said ATM network side, a loop-back transmission mode is set to said packet to be received by a second device on said ATM network side.

16. The loop detecting method according to claim 10, wherein, when a packet is transmitted from a first device on said ATM network side to a first device on said layer 2 network side, a loop route is formed on said layer 2 network side.

17. The loop detecting method according to claim 10, wherein logical transmission paths to be used for bidirectional connection in said ATM network are different from each other.

18. The loop detecting method according to claim 10, wherein a VRRP is applied in said ATM network and said layer 2 network.

19. An ATM (Asynchronous Transfer Mode) bridge device to which an ATM network and a layer 2 network are connected, comprising:
a first learning means to learn a transmitter address of a packet input from said ATM network and information about a transmission path through which said packet had been transmitted and to judge a destination of said packet based on a result from the learning;
a second learning means to learn a transmitter address of a packet input from said ATM network and information about a transmission path to which said packet is to be output; and
a packet scrapping judging means to compare said transmitter address of said packet input from said ATM network and information about said transmission path through which said packet had been transmitted with said transmitter address of said packet learnt by said second learning means and information about said transmission path to which said packet is to be output and, if said transmitter address of said packet input from said ATM network and information about said transmission path through which said packet had been transmitted are matched with said transmitter address of said packet learnt by said second learning means and information about said transmission path to which said packet is to be output, to scrap said packet.

20. The ATM bridge device according to claim 19, wherein, when a packet is transmitted from a first device on the ATM network side to a second device on said ATM network side, a loop-back transmission mode is set to said packet to be received by said second device.

21. The ATM bridge device according to claim 19, wherein, when a packet is transmitted from a first device on the layer 2 network side to a second device on said ATM network side, a loop-back transmission mode is set to said packet to be received by said second device on said ATM network side.

22. The ATM bridge device according to claim 19, wherein, when a packet is transmitted by a broadcast method from a first device on said ATM network side to other devices on said ATM network side, a loop-back transmission mode is set to said packet to be received by a second device on said ATM network side.

23. The ATM bridge device according to claim 19, wherein, when a packet is transmitted by a broadcast method from a first device on said ATM network side to other devices on said ATM network side, a loop-back transmission mode is set to said packet to be received by a second device and a third device on said ATM network side.

24. The ATM bridge device according to claim 19, wherein, when a packet is transmitted by a broadcast method from a first device on said layer 2 network side to a device on said ATM network side, a loop-back transmission mode is set to said packet to be received by a second device on said ATM network side.

25. The ATM bridge device according to claim 19, wherein, when a packet is transmitted from a first device on said ATM network side to a first device on said layer 2 network side, a loop route is formed on said layer 2 network side.

26. The ATM bridge device according to claim 19, wherein logical transmission paths to be used for bidirectional connection in said ATM network are different from each other.

27. The ATM bridge device according to claim 19, wherein a VRRP (Virtual Router Redundancy Protocol) is applied in said ATM network and said layer 2 network.
